(19) United States
(12) Patent Application Publication
(10) Pub. No.: US 2014/0140574 A1
(43) Pub. Date: May 22, 2014

(54) COMMODITY RECOGNITION APPARATUS AND COMMODITY RECOGNITION METHOD

(71) Applicant: TOSHIBA TEC KABUSHIKI KAISHA, Tokyo (JP)

(72) Inventor: Yuishi Takeno, Shizuoka-ken (JP)

(73) Assignee: TOSHIBA TEC KABUSHIKI KAISHA, Tokyo (JP)

(21) Appl. No.: 14/081,245

(22) Filed: Nov. 15, 2013

(30) Foreign Application Priority Data
Nov. 20, 2012 (JP) 2012-254082

(51) Int. Cl. G06K 9/00

(52) U.S. Cl. CPC G06K 9/00671
USPC 382/103

(57) ABSTRACT

A commodity recognition apparatus comprises an image interface, and a processor. The image interface acquires a commodity image captured by a camera. The processor detects a commodity image from the image acquired by the image interface. Then the processor carries out a commodity recognition processing for recognizing a commodity candidate according to feature amount extracted from the commodity image and a code reading processing for reading a commodity recognition code from the same commodity image in parallel. If the commodity recognition code is read in the code reading processing, the processor determines the commodity recognition code. If a photographing period of a commodity is ended while the commodity recognition code is not read, the processor outputs a result of the commodity recognition processing.

### CROSS-REFERENCE TO RELATED APPLICATION

This application is based upon and claims the benefit of priority from Japanese Patent Application No. 2012-254082, filed Nov. 20, 2012, the entire contents of which are incorporated herein by reference.

### FIELD

Embodiments described herein relate to a commodity recognition apparatus using a camera and a commodity recognition method for enabling a computer to function as the commodity recognition apparatus.

### BACKGROUND

Barcode is one kind of optical code attached to a commodity. Most of the commodities sold in a supermarket and the like are attached with a barcode including a commodity recognition code. A commodity recognition apparatus for recognizing the commodity recognition code by scanning the barcode with a scanner is being widely popularized.

However, not every commodity is attached with a barcode. For example, most commodities sold by retail such as vegetables, fruits, and deli food and the like are not attached with barcodes. Therefore, there exists a commodity recognition apparatus which uses a display device as a touch panel to deal with the commodity without a barcode. The apparatus displays an image of the commodity without a barcode on a screen of the touch panel. If the image of the commodity is selected through a touch input by an operator, the commodity recognition apparatus determines the commodity recognition code associated with the selected image of the commodity.

### BRIEF DESCRIPTION OF THE DRAWINGS

FIG. 1 is an external view of a store checkout system;

FIG. 2 is a block diagram illustrating hardware arrangements of a commodity recognition apparatus and a POS terminal;

FIG. 3 is a schematic view illustrating a structure of dictionary data for each commodity stored in a recognition dictionary file;

FIG. 4 is a schematic view illustrating an area structure of a candidate commodity memory;

FIG. 5 is a flowchart illustrating one procedure of information processing executed by a CPU of the commodity recognition apparatus according to a commodity recognition program in a first embodiment;

FIG. 6 is a flowchart specifically illustrating a procedure of commodity recognition processing in the first embodiment;

FIG. 7 is a flowchart specifically illustrating a procedure of recognition result processing in the first embodiment;

FIG. 8 is a plan view illustrating one example of a registration screen;

FIG. 9 is a plan view illustrating one example that a commodity candidate is displayed on the registration screen;

FIG. 10 is a flowchart specifically illustrating a procedure of commodity recognition processing in a second embodiment;

FIG. 11 is a flowchart specifically illustrating a procedure of recognition result processing in the second embodiment;

FIG. 12 is a flowchart illustrating a procedure of the information processing executed by the CPU of the commodity recognition apparatus according to the commodity recognition program in a third embodiment; and

FIG. 13 is a flowchart specifically illustrating a procedure of commodity recognition processing in the third embodiment.

### DETAILED DESCRIPTION

In accordance with one embodiment, a commodity recognition apparatus comprises an image interface, and a processor. The image interface acquires a commodity image captured by a camera. The processor detects a commodity image from the image acquired by the image interface. Then the processor carries out a commodity recognition processing for recognizing a commodity candidate according to feature amount extracted from the commodity image and a code reading processing for reading a commodity recognition code from the same commodity image in parallel. If the commodity recognition code is read in the code reading processing, the processor determines the commodity recognition code. If a photographing period of a commodity is ended while the commodity recognition code is not read, the processor outputs a result of the commodity recognition processing.

The present embodiment illustrates a case where functions according to the present invention are applied to a commodity recognition apparatus included in a store checkout system of a retail store.

First, the commodity recognition apparatus of the present embodiment adopts a technology of general object recognition. The general object recognition is a technology in which the category and the like of an object are recognized from the image data of the object captured by a camera. A computer extracts appearance feature amount of the object contained in the image from the image data. Then the computer calculates the similarity degree by comparing the extracted appearance feature amount with the feature amount data of a reference image registered in a recognition dictionary file, and then recognizes the category and the like of an object based on the similarity degree. A technology for recognizing an object contained in an image is disclosed in the following document.

Keiji Yanai “Current status and future direction of general object recognition”, Journal of Information Processing Society, Vol. 48, No. SIG16 [Search on Heisei 22 Aug. 2010], Internet <URL: http://mm.cs.uec.ac.jp/IPSJ-TCVIM-Yanai.pdf>

In addition, the technology carrying out the general object recognition by area division of the image for each object is described in the following document.

Jamie Shotton etc, “Semantic Texton Forests for Image Categorization and Segmentation”, [Search on Heisei 22 Aug. 2010], Internet <URL: http://citeseerx.ist.psu.edu/viewdoc/download?doi=10.1. 1.145.3036&rep=repl&type=pdf>

### A First Embodiment

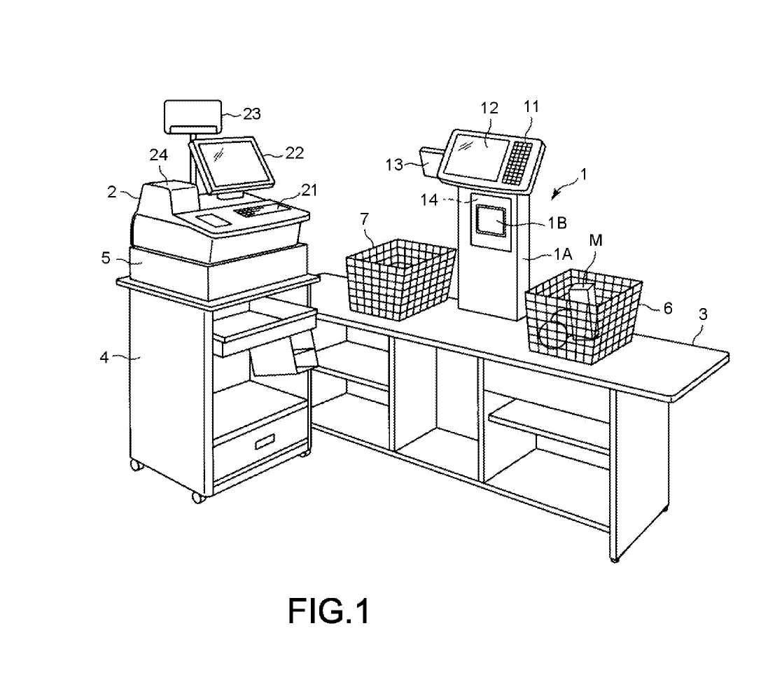

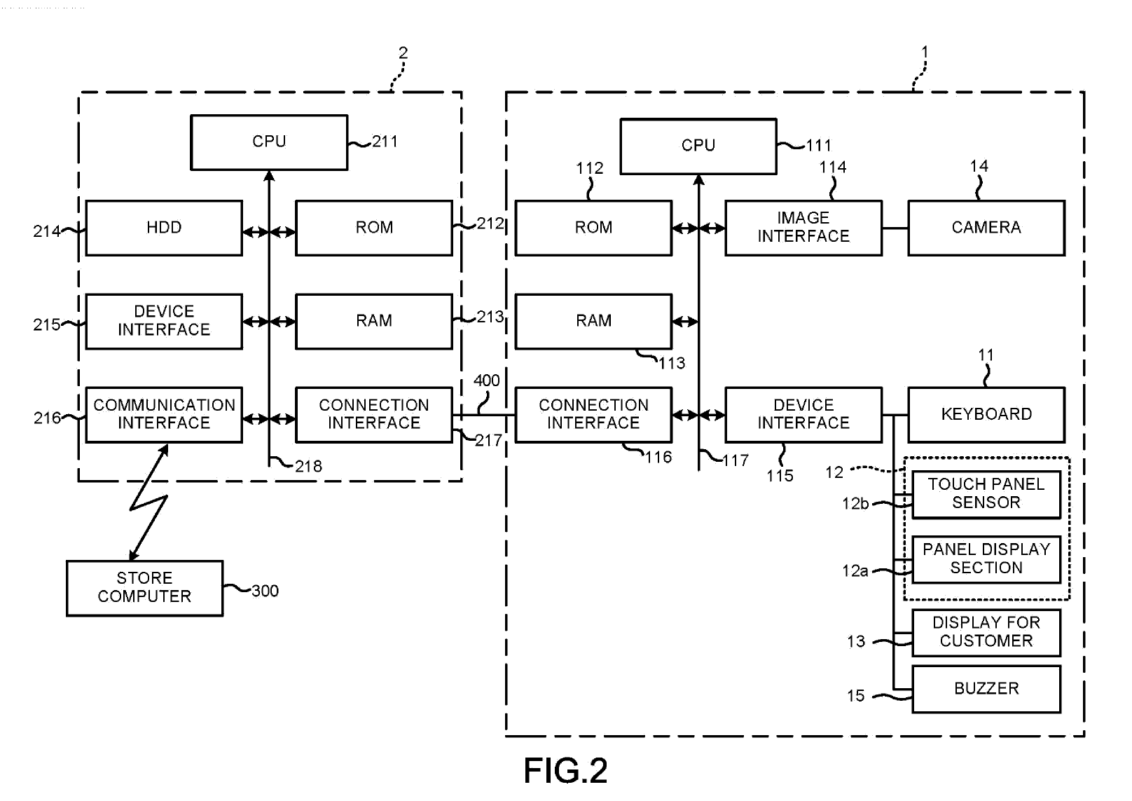

FIG. 1 is an external view of a store checkout system. The system comprises a commodity recognition apparatus 1 for recognizing a commodity purchased by a customer and a POS terminal 2 for registering sales data of the commodity recognized by the commodity recognition apparatus 1. The commodity recognition apparatus 1 is mounted on a checkout counter 3. The POS terminal 2 is arranged on a register table 4 via a drawer 5. The POS terminal 2 comprises a keyboard 21, a display for operator 22, a display for customer 23 and a receipt printer 24 which serve as devices required for settlement. The commodity recognition apparatus 1 is electrically connected with the POS terminal 2 through a communication cable 400 (referring to FIG. 2).

The checkout counter 3 is formed in an elongated-shape along a customer passage at the rear side of the checkout counter. The register table 4 is arranged substantially perpendicular to the checkout counter 3 in the nearer side of the end of the checkout counter 3 at the downstream side in the movement direction of a customer moving along the checkout counter 3. The checkout counter 3 and the register table 4 define a space for a shop clerk in charge of settlement, i.e., so called cashier.

The commodity recognition apparatus 1 comprises a keyboard 11, a touch panel 12 and a display for customer 13. These display and input devices (the keyboard 11, the touch panel 12 and the display for customer 13) are mounted on a housing 1A constituting a main body of the commodity recognition apparatus 1. The housing 1A in a thin rectangular shape is vertically arranged at the approximate center of the checkout counter 3. The keyboard 11 and the touch panel 12 are respectively arranged on the housing 1A in a manner that an operation surface faces the cashier. The display for customer 13 is arranged on the housing 1A in a manner that a display surface faces the customer passage.

A camera 14 is arranged in the housing 1A. In addition, a rectangular reading window 1B is formed on the front side (cashier side) of the housing 1A. The camera 14 comprises a CCD (Charge Coupled Device) image capturing element serving as an area image sensor and a drive circuit thereof, and an image capturing lens used for focusing an image of an image capturing area on the CCD image capturing element. The image capturing area refers to an area of a frame image focused in an area of the CCD image capturing element by the image capturing lens from the reading window 1B. The camera 14 outputs the image of the image capturing area focused on the CCD image capturing element through the image capturing lens.

In addition, the camera 14 is not limited to a configuration mentioned above. In the present embodiment, devices having a function of capturing a commodity are all included in the scope of the camera 14.

A first upper surface portion of the checkout counter 3 at the upstream side of the commodity recognition apparatus 1 in the customer movement direction serves as a space for placing a shopping basket 6 in which an unregistered commodity M purchased by a customer is held. On the other side, a second upper surface portion at the downstream side of the commodity recognition apparatus 1 serves as an another space for placing a shopping basket 7 in which a commodity M recognized by the commodity recognition apparatus 1 is held.

FIG. 2 is a block diagram illustrating hardware arrangements of the commodity recognition apparatus 1 and the POS terminal 2. The commodity recognition apparatus 1 includes a main control section, a main storage section and an input-output section. A CPU (Central Processing Unit) 111 serves as the main control section. A ROM (Read Only Memory) 112 and a RAM (Random Access Memory) 113 serve as the main storage section. An image interface 114, a device interface 115 and a connection interface 116 serve as the input-output section. The CPU 111 is connected with the ROM 112, the RAM 113 and each interface 114, 115 and 116 through a bus line 117 such as an address bus, a data bus and the like.

In addition, the main control section can be also other processor rather than a CPU. In addition, the input-output section can include other interface.

The image interface 114 is connected with the camera 14. The image captured by the camera 14 is acquired by the commodity recognition apparatus 1 through the image interface 114, and is stored in the RAM 113. The device interface 115 is connected with the keyboard 11, the touch panel 12 and the display for customer 13. The touch panel 12 includes a panel display section 12a and a touch panel sensor 12b. The touch panel sensor 12b is overlaid on a screen of the panel display section 12a. In addition, a buzzer 15 for giving a notification sound is also connected with the device interface 115. Further, in the present embodiment, devices having a function of notifying an operator through a sound are all included in the scope of the buzzer.

The POS terminal 2 includes a main control section, a main storage section, an auxiliary storage section and an input-output section. A CPU 211 serves as the main control section. A ROM 212 and a RAM 213 serve as the main storage section. An HDD (Hard Disk Drive) 214 serves as the auxiliary storage section. A device interface 215, a communication interface 216 and a connection interface 217 serve as the input-output section. The CPU 211 is connected with the ROM 212, the RAM 213, the HDD 214 and each interface 215, 216 and 217 through a bus line 218 such as an address bus, a data bus and the like.

In addition, the main control section can be also other processor rather than a CPU. In addition, the input-output section can include other interface. In addition, the auxiliary storage section is not limited to the HDD 214. For example, a SSD (Solid State Drive) can be also used as the auxiliary storage section.

The device interface 215 is connected with the keyboard 21, the display for operator 22, the display for customer 23, the printer 24 and the drawer 5 which are omitted in FIG. 2.

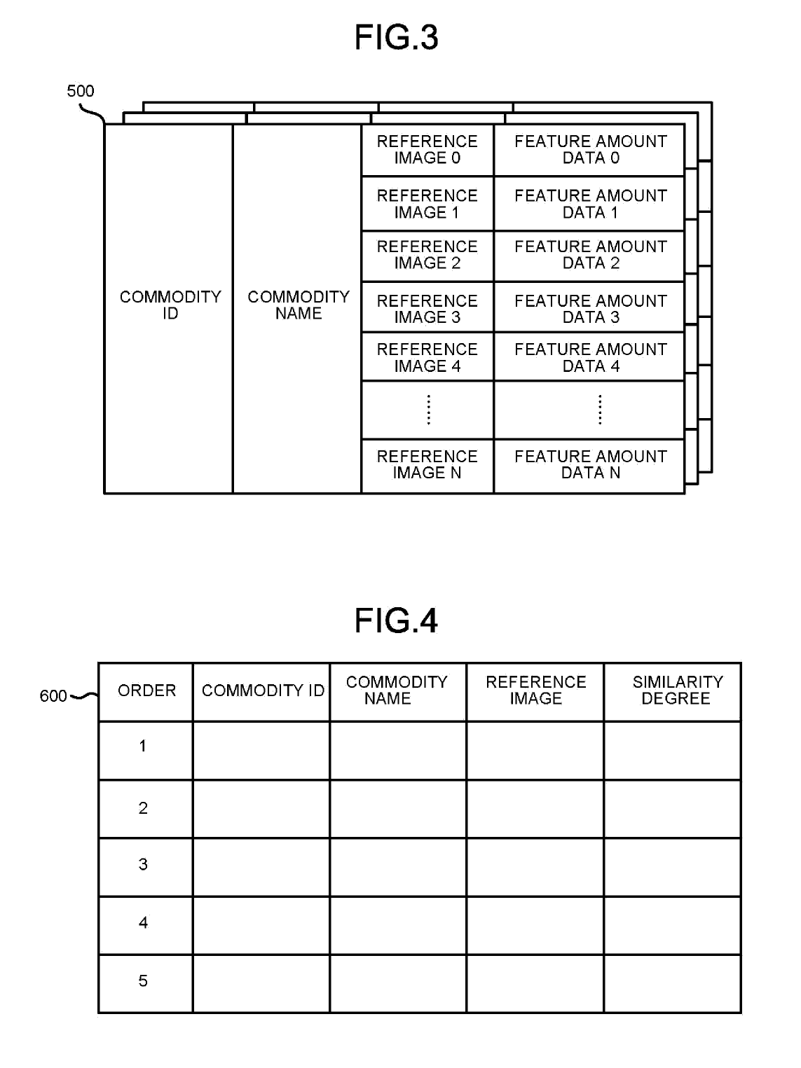

The communication interface 216 is connected with a store computer 300 serving as the center of a store through a network such as a LAN (Local Area Network) and the like. Through the connection, the POS terminal 2 can carry out data transmission/reception with the store computer 300. For example, the POS terminal 2 receives a recognition dictionary file 500 (referring to FIG. 3) from the store computer 300 through the communication interface 216. The recognition dictionary file 500 is stored in the HDD 214.

The connection interface 217 is connected with the connection interface 116 of the commodity recognition apparatus 1 through the communication cable 400. Through the connection, the POS terminal 2 displays commodity sales data on the touch panel 12 and the display for customer 13 of the commodity recognition apparatus 1. The commodity recognition apparatus 1 can access the recognition dictionary file 500 stored in the HDD 214 of the POS terminal 2.

In the present embodiment, the commodity without a barcode serving as an optical code is used as a recognition target commodity. The recognition dictionary file 500 stores dictionary data for each recognition target commodity. FIG. 3 is a schematic view illustrating a structure of the dictionary data. As shown in FIG. 3, for each recognition target commodity, a plurality of pairs of reference image data 0 to N and feature amount data 0 to N are stored in the recognition dictionary file 500 in association with a commodity ID and a commodity name. The commodity ID is the commodity recognition code for recognizing the commodity. In addition, the commodity ID mentioned above is included in the barcode attached to the commodity.

The reference image data 0 to N are the image data obtained by capturing a commodity recognized using a corresponding commodity ID from various directions. The feature amount data 0 to N are data obtained by extracting appearance feature amount serving as surface information (an appearance shape, a hue, a pattern, a concave-convex state and the like) of the commodity from reference images 0 to N of the corresponding commodity and parameterizing the appearance feature amount.

In addition, the number (n+1) of the reference image data and the feature amount data relative to one commodity is not fixed. The number (n+1) of the image data and the feature amount data is different according to the commodity. In addition, the reference image data 0 to N are not all stored in the recognition dictionary file 500, and any one reference image data can be stored in the recognition dictionary file 500.

The commodity recognition apparatus 1 has an image detection function, a reading function, a feature amount extraction function, a similarity degree calculation function, a commodity recognition function, and a result output function to determine a commodity M put in the image capturing area of the camera 14 as a commodity for sale.

The image detection function is used for detecting a commodity image from the image of the commodity captured by the camera 14. The reading function is used for reading a barcode from the commodity image detected by the image detection function. In addition, the reading function may also be used for reading other optical code, for example, a two-dimensional data code, instead of the barcode.

The feature amount extraction function is used for extracting appearance feature amount of a commodity from the commodity image detected by the image detection function. The similarity degree calculation function is used for comparing the appearance feature amount extracted by the feature amount extraction function with the feature amount data for each recognition target commodity stored in the recognition dictionary file 500. Afterwards, the similarity degree calculation function is used for calculating a similarity degree representing how similar the appearance feature amount is to the feature amount data for each recognition target commodity. The commodity recognition function is used for recognizing a candidate of a commodity captured by the camera 14 based on the similarity degree for each recognition target commodity calculated by the similarity degree calculation function.

The result output function is used for outputting a commodity ID obtained by analyzing a barcode in a case where the barcode is read by the reading function to the POS terminal 2 as a commodity ID of the commodity captured by the camera 14. In addition, the result output function is used for outputting a commodity ID of a commodity specified from the commodity candidates recognized by the commodity recognition function to the POS terminal 2 as a commodity ID of the commodity captured by the camera 14.

In order to realize these functions, the commodity recognition apparatus 1 stores a commodity recognition program in the ROM 112. In addition, the commodity recognition apparatus 1 guarantees an area serving as the candidate commodity memory 600 in the RAM 113.

As shown in FIG. 4, the candidate commodity memory 600 stores the data of the commodity ID, the commodity name, the reference image and the similarity degree for each commodity ranked at the first to the fifth. In addition, in the candidate commodity memory 600, the order is not limited to be from the first to the fifth. For example, that how many numbers of data are stored can be randomly set by a user of a system.

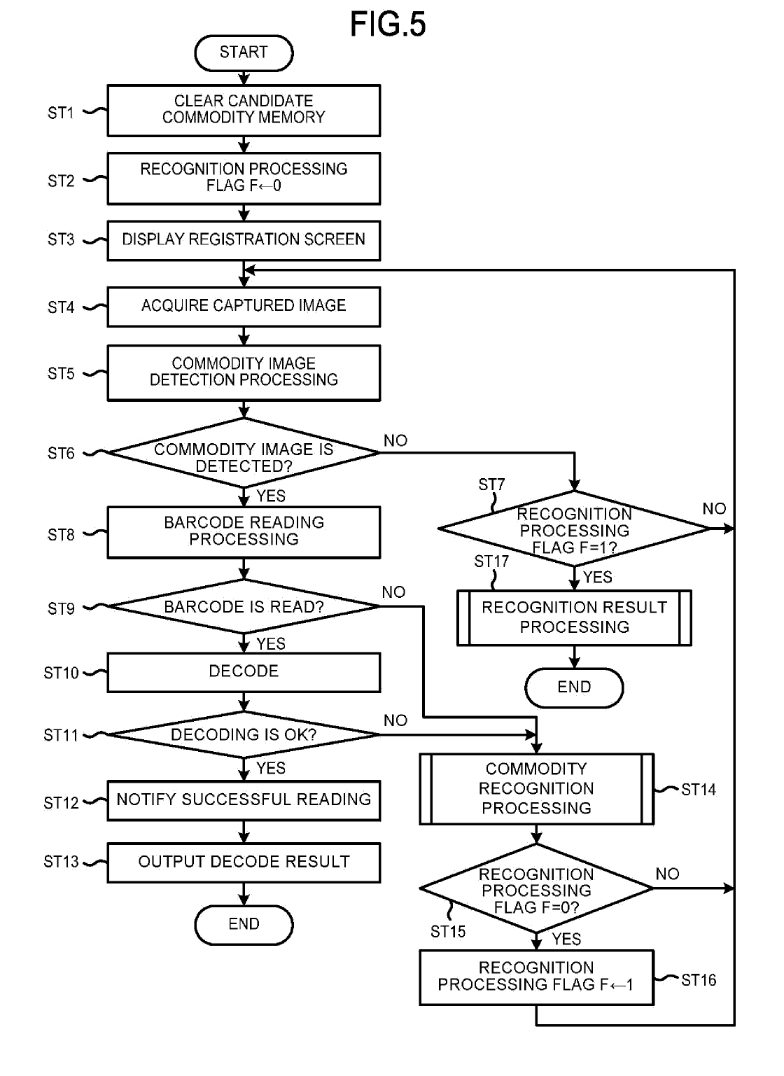

The CPU 111 of the commodity recognition apparatus 1 executes information processing in a procedure shown in a flowchart in FIG. 5 according the commodity recognition program. First, the CPU 111 executes each processing from ACT ST1 to ACT ST3. In ACT ST1, the CPU 111 clears the candidate commodity memory 600. In ACT ST2, the CPU 111 resets a recognition processing flag F to be “0”. The recognition processing flag F is stored in, for example, the RAM113. In ACT ST3, the CPU 111 displays a registration screen 700 on the panel display section 12a of the touch panel 12.

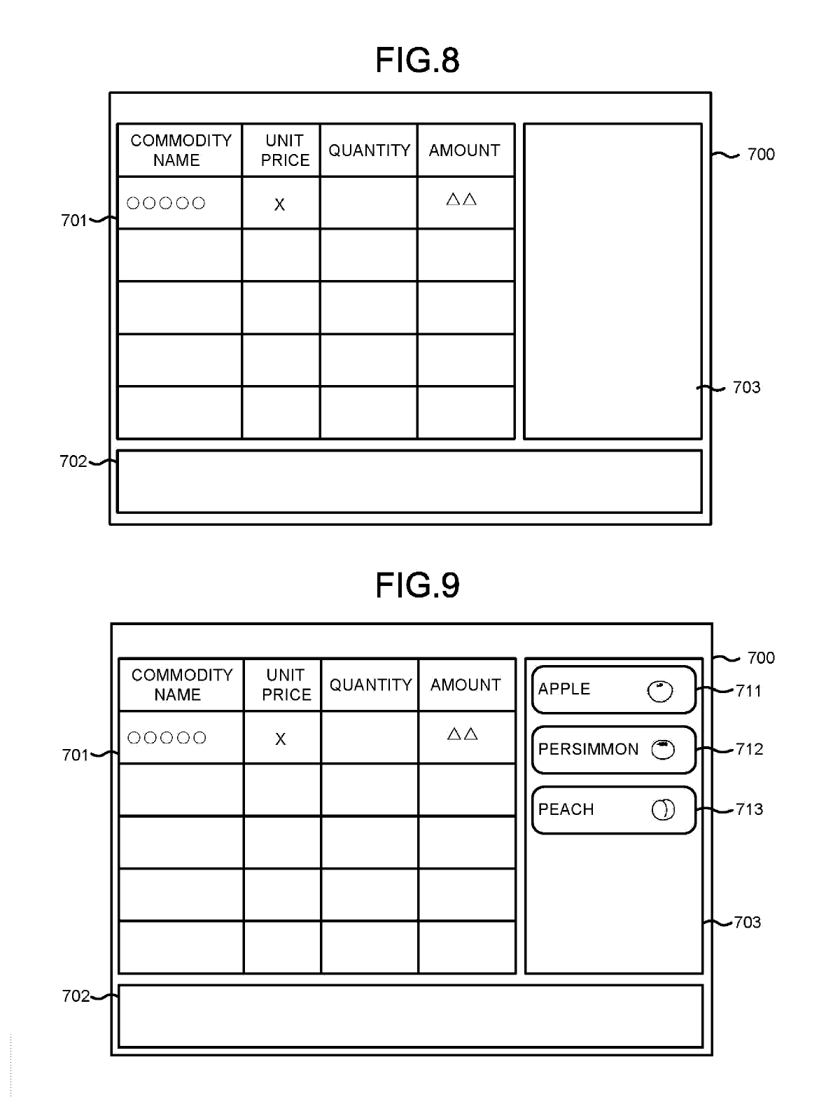

One example of the registration screen 700 is shown in FIG. 8. The registration screen 700 includes a detail area 701, a total area 702 and a candidate area 703. The commodity name, the unit price, the quantity and the amount of the commodity registered as a commodity for sale are displayed in the detail area 701. The total point and the total amount of the registered commodity are displayed in the total area 702. The commodity name and the reference image stored in the candidate commodity memory 600 are displayed sequentially from the first one in the candidate area 703.

The CPU 111 acquires the image (frame image) captured by the camera 14 through the image interface 114 (ACT ST4). The captured image acquired is stored in an image buffer of the RAM 113.

The CPU 111 analyzes the captured image stored in the image buffer and detects a commodity image from the captured image (ACT ST5: image detection function). Specifically, the CPU 111 extracts a contour line and the like from a binary image of the frame image. Afterwards, the CPU 111 tries to extract the contour of the object imaged in the image. If the contour of the object is extracted, the CPU 111 regards the image in the contour as the commodity image.

The CPU 111 confirms whether or not the commodity image is detected from the captured image (ACT ST6). If the commodity image is not detected (NO in ACT ST6), the CPU 111 confirms the state of the recognition processing flag F (ACT ST7). At this time, the recognition processing flag F is reset to be “0”. Therefore, the CPU 111 returns to the processing in ACT ST4. That is, the CPU 111 acquires a next frame image from the camera 14, and executes a commodity image detection processing.

In this way, the CPU 111 executes a commodity image detection processing every time a frame image is acquired from the camera 14. If the commodity is put in front of the reading window 1B, the commodity image is detected from the frame image. If the commodity image is detected (YES in ACT ST6), the CPU 111 analyzes the commodity image and tries to read the barcode (ACT ST8: reading function). A technology for reading the barcode based on image analysis is recorded in, for example, Japanese Unexamined Patent Application Publication No. 2008-033640.

The CPU 111 confirms whether or not the barcode is read from the commodity image (ACT ST9). If the barcode is read (YES in ACT ST9), the CPU 111 decodes the barcode (ACT ST10). Then the CPU 111 confirms whether or not the barcode can be decoded (ACT ST11). If the barcode can be decoded (YES in ACT ST11), the CPU 111 executes each processing in ACT ST12 and ACT ST13. In ACT ST12, the CPU 111 outputs a signal to drive the buzzer 15 to sound to notify that the reading is successful. In ACT ST13, the CPU 111 outputs the decode result of the barcode to the POS terminal 2 through the connection interface 116 (result output function).

If the barcode is not read from the commodity image in ACT ST9 (NO in ACT ST9), or if the barcode cannot be decoded in ACT ST11 (NO in ACT ST11), the CPU 111 executes commodity recognition processing (ACT ST14).

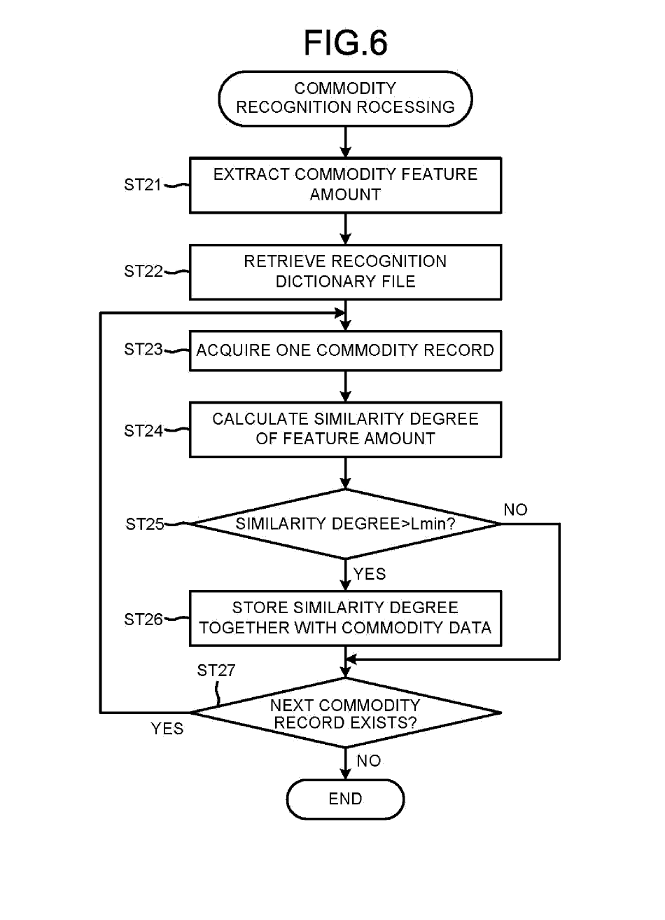

FIG. 6 is a flowchart specifically illustrating a procedure of the commodity recognition processing. First, the CPU 111 extracts appearance feature amount of the commodity from the commodity image detected in the processing in ACT ST5 (ACT ST21: feature amount extraction function). The shape, the surface hue, the pattern, the concave-concave state and the like of the commodity are included in the appearance feature amount. If the appearance feature amount of the commodity is extracted, the CPU 111 accesses the HDD 214 of the POS terminal 2, and retrieves the recognition dictionary file 500 (ACT ST22). Afterwards, the CPU 111 reads a data record (the commodity ID, the commodity name, the reference images 0 to N and the feature amount data 0 to N) of one commodity from the recognition dictionary file 500 (ACT ST23).

If the data record of one commodity is read, the CPU 111 calculates a similarity degree for each feature amount data 0 to N of the record. The similarity degree is a value representing how similar the feature amount data 0 to N are to the appearance feature amount of the commodity extracted in the processing in ACT ST21. The CPU 111 determines the highest similarity degree in the similarity degrees calculated for each feature amount data 0 to N as the similarity degree between the recognition target commodity specified with the commodity ID of the record and the commodity captured by the camera 14 (ACT ST24: similarity degree calculation function). In addition, a total value or an average value of the similarity degrees calculated for each feature amount data 0 to N can be also determined as the similarity degree between the recognition target commodity and the captured commodity.

The CPU 111 confirms whether or not the similarity degree determined through the processing in ACT ST24 exceeds a preset candidate threshold value Lmin (ACT ST25). The candidate threshold value Lmin is a lower limit value of the similarity degree which retains the recognition target commodity as a candidate commodity. When the similarity degree does not exceed the candidate threshold value Lmin (NO in ACT ST25), the CPU 111 enters the processing in ACT ST27.

When the similarity degree exceeds the candidate threshold value Lmin (YES in ACT ST25), the CPU 111 stores the similarity degree together with the commodity ID, the commodity name and the reference image of the record in a candidate buffer of the RAM 113 (ACT ST26: commodity recognition function). The reference image is obtained by, for example, selecting a reference image corresponding to the feature amount data having the highest similarity degree. Subsequently, the CPU 111 enters the processing in ACT ST27.

In ACT ST27, the CPU 111 confirms whether or not an unprocessed data record exists in the recognition dictionary file 500. If the unprocessed data record exists (YES in ACT ST27), the CPU 111 returns to carry out the processing in ACT ST23. Namely, the CPU 111 reads the unprocessed data record from the recognition dictionary file 500, and then executes the processing from ACT ST24 to ACT ST26 again.

When the unprocessed data record does not exist in the recognition dictionary file 500 (NO in ACT ST27), the commodity recognition processing is ended.

If the commodity recognition processing is ended, the CPU 111 checks the state of the recognition processing flag F (ACT ST15). When the recognition processing flag F is reset to be “0” (YES in ACT ST15), the CPU 111 sets the recognition processing flag F to be “1” (ACT ST16). When the recognition processing flag F is already set to be “1” (NO in ACT ST15), the CPU 111 does not execute the processing in ACT ST16. The CPU 111 returns to the processing in ACT ST4. That is, the CPU 111 acquires a next frame image from the camera 14, and executes commodity image detection processing.

The commodity image is detected from the frame image during a period from the moment the commodity is put in front of the reading window 1B to the moment the commodity is moved out from the image capturing area of the camera 14. Therefore, during the period, the CPU 111 executes the processing following ACT ST8. That is, the CPU 111 executes the barcode reading processing and the commodity recognition processing in parallel using the commodity image detected from the frame image. Afterwards, when the barcode is read through the barcode reading processing, the CPU 111 outputs the commodity ID decoded from the barcode to the POS terminal 2.

If the commodity is moved out from the image capturing area of the camera 14 while the barcode is not read, the commodity image cannot be detected from the frame image. At this time, the recognition processing flag F is set to be “1” (YES in ACT ST7). Therefore, the CPU 111 executes recognition result processing (ACT ST17).

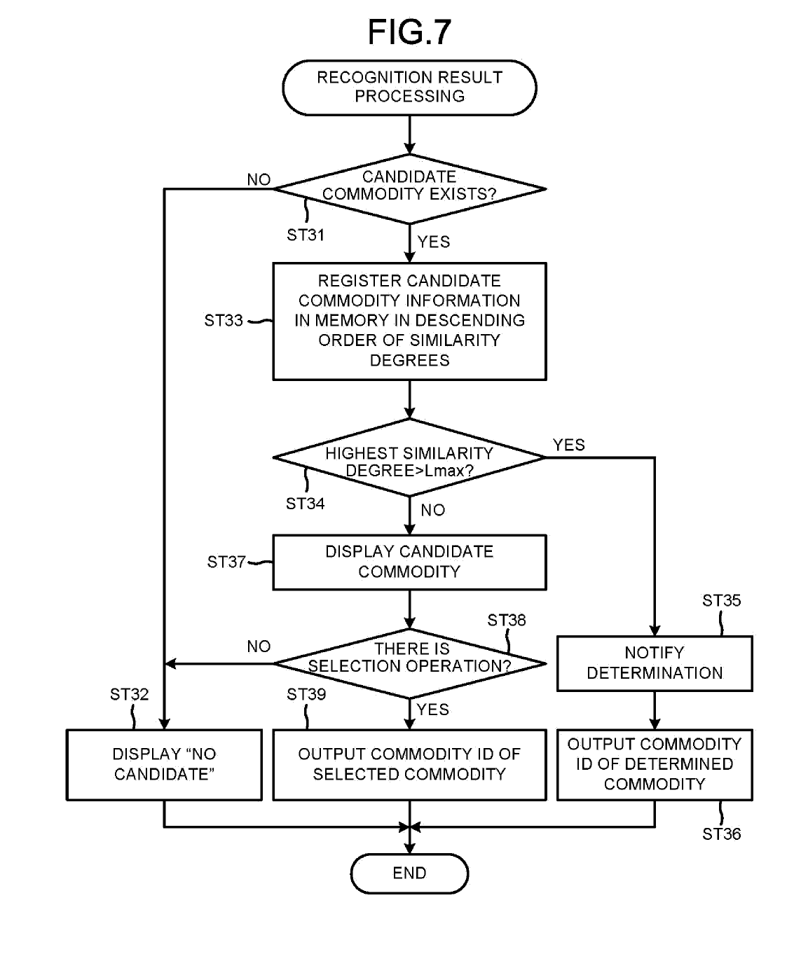

FIG. 7 is a flowchart specifically illustrating a procedure of the recognition result processing. First, the CPU 111 confirms whether or not the data (the commodity ID, the commodity name, the reference image and the similarity degree) are stored in the candidate buffer (ACT ST31). When no data is stored in the candidate buffer (NO in ACT ST31), the CPU 111 displays a message of “no candidate” in the candidate area 703 of the registration screen 700 (ACT ST32).

When data is stored in the candidate buffer (YES in ACT ST31), the CPU 111 rearranges the data in the candidate buffer in the descending order of similarity degrees. Afterwards, the CPU 111 selects the data (the commodity ID, the commodity name, the reference image and the similarity degree) of which the similarity degrees are ranked from the first to the fifth, and registers the data in the candidate commodity memory 600 in a descending order (ACT ST33). When the registration of data is ended, the CPU 111 clears the candidate buffer.

Next, the CPU 111 confirms whether or not the similarity degree of the data registered at the first place in the candidate commodity memory 600, that is, the highest similarity degree, exceeds a preset determination threshold value Lmax (Lmax>Lmin) (ACT ST34). The determination threshold value Lmax is a lower limit value of the similarity degree which can determine the recognition target commodity to be the commodity put in front of the reading window 1B.

If the highest similarity degree exceeds the determination threshold value Lmax (YES in ACT ST34), the CPU 111 executes each processing in ACT ST35 and ACT ST36. In ACT ST35, the CPU 111 outputs a signal to drive the buzzer 15 to sound to notify the recognition determination. In ACT ST36, the CPU 111 reads the commodity ID of the data registered at the first place in the candidate commodity memory 600. Then the CPU 111 outputs the commodity ID to the POS terminal 2 through the connection interface 116 (result output function).

If the highest similarity degree does not exceed the determination threshold value Lmax (NO in ACT ST34), the CPU 111 displays the image of the candidate commodity in the candidate area 703 according to the order of the registration in the candidate commodity memory 600 (ACT ST37).

One example of the registration screen 700 displaying a candidate commodity image is illustrated in FIG. 9. In this example, “apple”, “persimmon” and “peach” are recognized as the candidate commodities. The similarity degree of “apple” is the highest, and the similarity degree of “peach” is the lowest. In this case, as shown in FIG. 9, a button image 711 for selecting “apple”, a button image 712 for selecting “persimmon” and a button image 713 for selecting “peach” are displayed in the candidate area 703.

If the button images 711, 712 and 713 of the candidate commodities are displayed, the CPU 111 confirms whether or not any one commodity in the candidate commodities is selected (ACT ST38). If any one button image is touched, the CPU 111 regards that the commodity displayed on the button image is selected (YES in ACT ST38). The CPU 111 outputs the commodity ID of the selected commodity to the POS terminal 2 through the connection interface 116 (ACT ST39: result output function).

If no commodity is selected (NO in ACT ST38), the CPU 111 displays a message of “no candidate” in the candidate area 703 of the registration screen 700 (ACT ST32). Then the recognition result processing is ended.

When the decode result of the barcode is output in ACT ST13, or when the recognition result processing is ended in ACT ST17, the CPU 111 ends the processing on the commodity put in front of the reading window 1B.

The commodity ID is contained in the decode result of the barcode sent to the POS terminal 2. In addition, in the recognition result processing, the commodity ID of the determined commodity or the selected commodity is sent to the POS terminal 2. In order to acquire commodity information such as the commodity name, the unit price and the like of the commodity recognized with the commodity ID received from the commodity recognition apparatus 1, the CPU 211 of the POS terminal 2 retrieves a commodity master file. Afterwards, the CPU 211 carries out registration processing on the commodity sales data including a sales quantity and a sales amount based on the commodity information retrieved from the commodity master file. In addition, the CPU 211 sends each data of the commodity name, the unit price, the quantity and the amount to the commodity recognition apparatus 1 through the connection interface 217. The CPU 111 of the commodity recognition apparatus 1 displays each data of the commodity name, the unit price, the quantity and the amount received from the POS terminal 2 on the detail area 701 of the registration screen 700 displayed on the panel display section 12a and the display for customer 13.

Herein, the CPU 111 functions as a processor for carrying out the commodity recognition processing and the code reading processing in parallel using the same commodity image detected from the frame image. If the commodity ID (commodity recognition code) is read in the code reading processing, the CPU 111 determines the commodity ID. If a photographing period of a commodity is ended while the commodity ID is not read, the CPU 111 outputs a result of the commodity recognition processing. It is regarded that the photographing period is ended if the commodity image cannot be detected from the frame image.

In the present embodiment, an operator of the commodity recognition apparatus 1 confirms whether or not a barcode is attached to a commodity M every time a commodity M is taken out one by one from the shopping basket 6. When the commodity M is attached with a barcode, the operator puts the surface of the commodity M with the barcode in front of the reading window 1B. When the commodity M is not attached with a barcode, the operator puts any surface of the commodity M in front of the reading window 1B.

The commodity M put in front of the reading window 1B is captured by the camera 14. In the commodity recognition apparatus 1, if a commodity image is detected from the frame image captured by the camera 14, the barcode reading processing and the commodity recognition processing are executed in parallel using the commodity image. As a result, if a barcode is read, the commodity ID decoded from the barcode is sent to the POS terminal 2.

On the other hand, if the commodity is not detected from the captured image while the barcode is not read, the recognition result processing is executed in the commodity recognition apparatus 1. That is, in the recognition result processing, if the highest similarity degree exceeds the determination threshold value Lmax, the commodity ID of the commodity (determined commodity) having the highest similarity degree is sent to the POS terminal 2. If the highest similarity degree does not exceed the determination threshold value Lmax, one or a plurality of candidate commodities of which the similarity degree exceed the candidate threshold value Lmin are displayed on the touch panel 12. If one commodity is selected from the candidate commodities, the commodity ID of the selected commodity is sent to the POS terminal 2.

In the commodity recognition apparatus 1, the barcode reading processing and the commodity recognition processing are executed in parallel as stated above when the operator puts the commodity in front of the reading window 1B. However, when the commodity is put in front of the reading window 1B, the result of the barcode reading processing is preferentially adopted. When the commodity is moved out from the image capturing area of the camera 14, the result of the commodity recognition processing becomes effective.

The commodity ID decoded from the barcode read through the barcode reading processing is highly reliable. On the contrary, the recognition precision of the commodity recognition processing is not very reliable. For example, a wrong commodity may be determined from a pattern of vegetable or fruit printed on the package of the commodity. In the present embodiment, when the commodity is put in front of the reading window 1B, the result of the barcode reading processing is preferentially adopted. Therefore, it is prevented that the result of the commodity recognition processing is preferentially adopted no matter whether or not the barcode is read from the commodity image captured by the camera 14, and that the commodity ID with low reliability is sent to the POS terminal 2.

In addition, in the commodity recognition apparatus 1, the barcode reading processing and the commodity recognition processing are executed in parallel. Therefore, it is not necessary to construct a structure in which if one processing fails, then the other processing is properly activated through a particular operation. Therefore, the operator can work without too much burden even in a case where the commodity attached with a barcode is mixed with the commodity attached with no barcode.

### A Second Embodiment

In the first embodiment, an operator is not notified even if the commodity candidate of which the similarity degree exceeds the determination threshold value Lmax is recognized in the process of commodity recognition processing. As a result, there exists concern that the operator may put the commodity with no barcode in front of the reading window 1B for a long time, which is not necessary. Therefore, the second embodiment for eliminating the concern mention above is described next.

The second embodiment is acquired by changing part of the commodity recognition processing and the recognition result processing in the first embodiment. Therefore, FIG. 1 to FIG. 5 and FIG. 8, FIG. 9 are also used in the second embodiment.

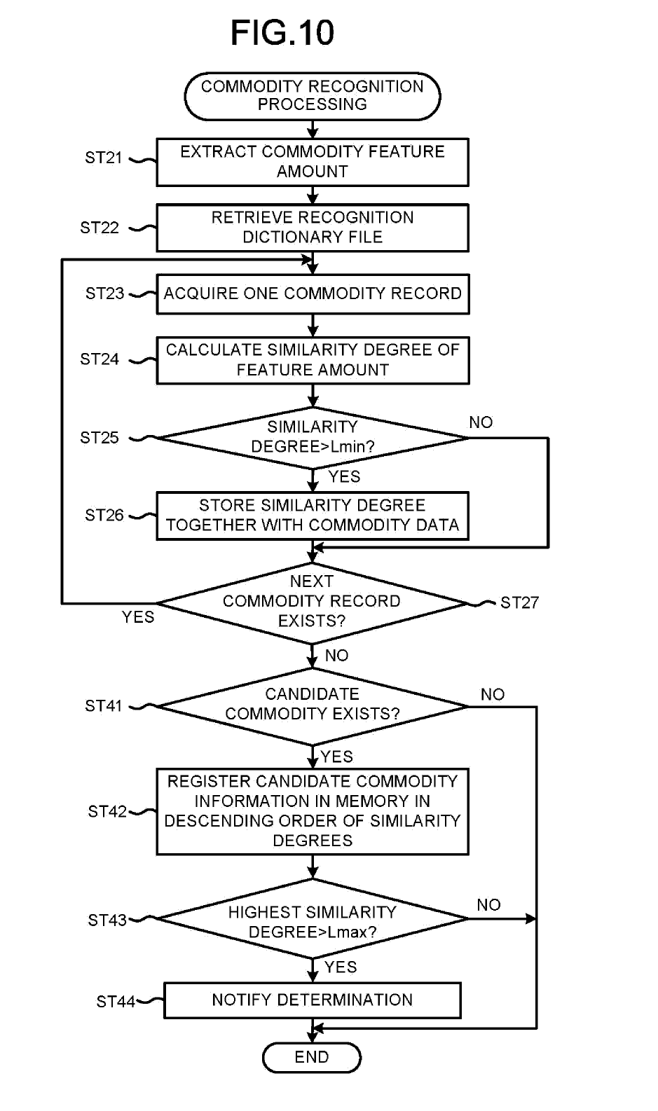

FIG. 10 is a flowchart specifically illustrating a procedure of commodity recognition processing in the second embodiment. In addition, the processing action the same as that in the commodity recognition processing of the first embodiment shown in FIG. 6 is assigned with the same reference mark, and is not repeatedly described.

As shown in FIG. 10, in the commodity recognition processing in the second embodiment, the processing from ACT ST21 to ACT ST27 is the same as that in the first embodiment. In ACT ST27, if it is confirmed that unprocessed data record does not exist in the recognition dictionary file 500 (NO in ACT ST27), the CPU 111 confirms whether or not data (the commodity ID, the commodity name, the reference image and the similarity degree) are stored in the candidate buffer (ACT ST41). If no data is stored in the candidate buffer (NO in ACT ST41), the commodity recognition processing is ended.

If data are stored in the candidate buffer (YES in ACT ST41), the CPU 111 rearranges the data in the candidate buffer in the descending order of similarity degrees. Afterwards, the CPU 111 selects the data (the commodity ID, the commodity name, the reference image and the similarity degree) of which the similarity degrees are ranked from the first to the fifth, and then registers the data in the candidate commodity memory 600 in a descending order (ACT ST42). When the registration of data is ended, the CPU 111 clears the candidate buffer.

Next, the CPU 111 confirms whether or not the similarity degree of the data registered at the first place in the candidate commodity memory 600, that is, the highest similarity degree, exceeds a preset determination threshold value Lmax (Lmax>Lmin) (ACT ST43). If the highest similarity degree does not exceed the determination threshold value Lmax (NO in ACT ST43), the commodity recognition processing is ended.

If the highest similarity degree exceeds the determination threshold value Lmax (YES in ACT ST43), the CPU 111 outputs a signal to drive the buzzer 15 to sound to notify the recognition determination (ACT ST44: notification function). Then the commodity recognition processing is ended.

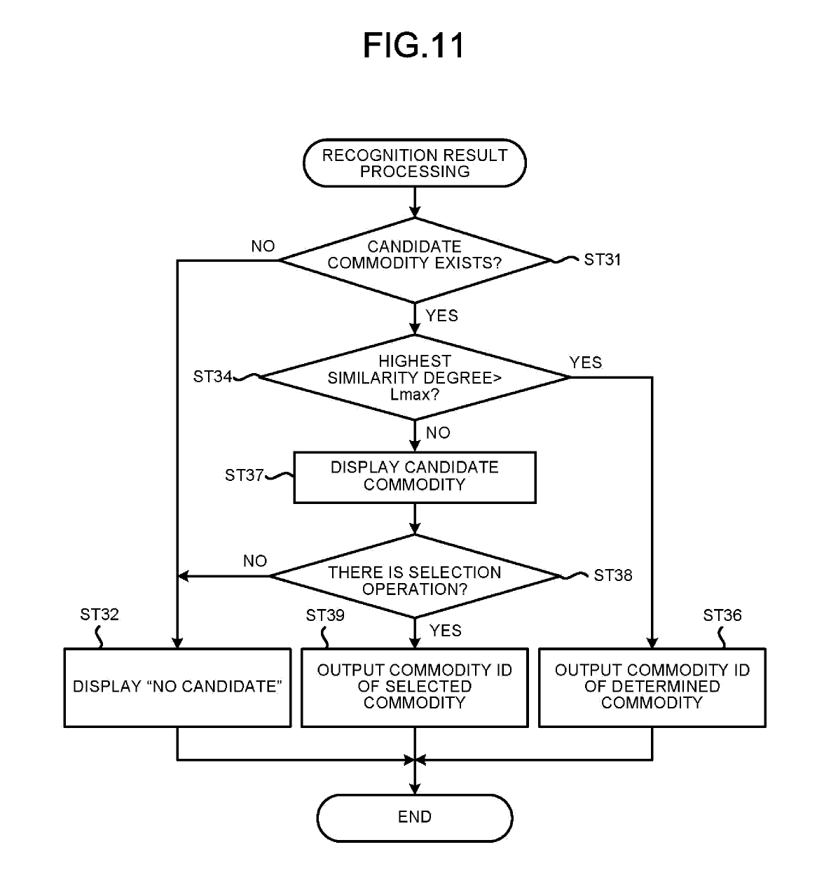

FIG. 11 is a flowchart specifically illustrating a procedure of recognition result processing in the second embodiment. In addition, the processing action the same as that in the recognition result processing of the first embodiment shown in FIG. 7 is assigned with the same reference mark, and is not repeatedly described.

As shown in FIG. 11, in the recognition result processing in the second embodiment, the processing in ACT ST33 and ACT ST35 is omitted. The processing in ACT ST33 is executed in ACT ST42 of the commodity recognition processing. The processing in ACT ST35 is executed in ACT ST44 of the commodity recognition processing. Therefore, the processing in ACT ST33 and ACT ST35 can be omitted.

In the commodity recognition apparatus 1 of the second embodiment, if the commodity candidate of which the similarity degree exceeds the determination threshold value Lmax is recognized in the process of commodity recognition processing (YES in ACT ST43), a buzzer sound is given to notify the recognition determination (ACT ST44). Thereby, the operator is surely notified that the commodity put in front of the reading window 1B is recognized through the commodity recognition processing. The operator notified of the recognition stops putting the commodity in front of the reading window and starts to do the next job. Therefore, according to the second embodiment, the work efficiency of the operator can be improved.

### A Third Embodiment

In the first and the second embodiment, when a commodity is put in front of the reading window 1B, the commodity recognition apparatus 1 executes the barcode reading processing and the commodity recognition processing in parallel. Therefore, as to the commodity attached with a barcode, the processing burden is large since the commodity recognition processing is executed until the barcode is read. Therefore, the third embodiment for lightening the processing burden is described next.

The third embodiment is acquired by changing part of the information processing executed by the CPU 111 according to the commodity recognition program in the first embodiment. In addition, part of the commodity recognition processing is also changed. Therefore, FIG. 1 to FIG. 4 and FIG. 7 to FIG. 9 are also used in the third embodiment.

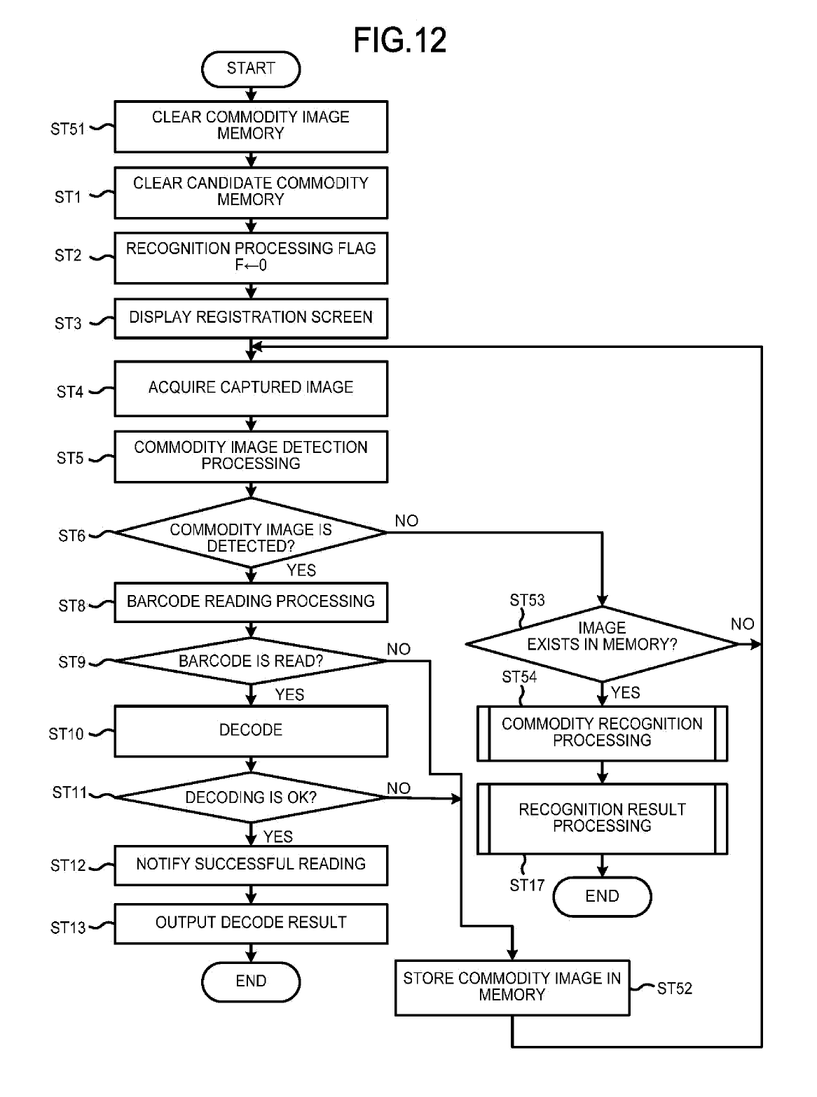

FIG. 12 is a flowchart illustrating a procedure of the information processing executed by the CPU 111 of the commodity recognition apparatus 1 according to the commodity recognition program in the third embodiment. In addition, the processing action the same as that in the first embodiment shown in FIG. 5 is assigned with the same reference mark, and is not repeatedly described.

As shown in FIG. 12, in the third embodiment, the CPU 111 first clears a commodity image memory (ACT ST51). The commodity image memory is an area for storing the commodity image detected from the image acquired by the image interface 114, and is formed in, for example, the RAM 113. Then the CPU 111 executes the processing the same as that from ACT ST1 to ACT ST6 in the first embodiment. In addition, the timing of clearing the commodity image memory and the candidate commodity memory 600 is not limited to the present embodiment. The CPU 111 may also clear the candidate commodity memory 600 first and then clear the commodity image memory.

If the result of the image detection processing in ACT ST5 is that the commodity image is not detected from the captured image (NO in ACT ST6), the CPU 111 confirms whether or not the image data is stored in the commodity image memory (ACT ST53). The image data is not stored in the commodity image memory before the commodity is put in front of the reading window 1B. In this case (NO in ACT ST53), the CPU 111 returns to the processing in ACT ST4. That is, the CPU 111 acquires a next frame image from the camera 14 and then executes the commodity image detection processing.

If the commodity image is detected (YES in ACT ST6), the CPU 111 executes the barcode reading processing like in the first embodiment (ACT ST8). If the barcode is read (YES in ACT ST9), the CPU 111 executes the processing the same as that from ACT ST10 to ACT ST13 in the first embodiment.

On the contrary, if the barcode cannot be read from the commodity image (NO in ACT ST9), or if the barcode cannot be decoded (NO in ACT ST11), the CPU 111 stores the commodity image in the commodity image memory (ACT ST52). Then the CPU 111 returns to the processing in ACT ST4.

During the period from the moment the commodity is put in front of the reading window 1B to the moment the commodity is moved out from the image capturing area of the camera 14, the commodity image is continuously detected from the frame image. Therefore, during the period, the CPU 111 repeatedly executes the processing following ACT ST8. That is, the CPU 111 executes the barcode reading processing using the commodity image detected from the frame image. Afterwards, when the barcode is read, the CPU 111 outputs the commodity ID decoded from the barcode to the POS terminal 2.

If the barcode is not read, the CPU 111 stores the commodity image in the commodity image memory. Then, if the commodity is moved out from the image capturing area of the camera 14 while the barcode is not read, the commodity image cannot be detected from the frame image. At this time, since the commodity image is stored in the commodity image memory, the CPU 111 executes the commodity recognition processing.

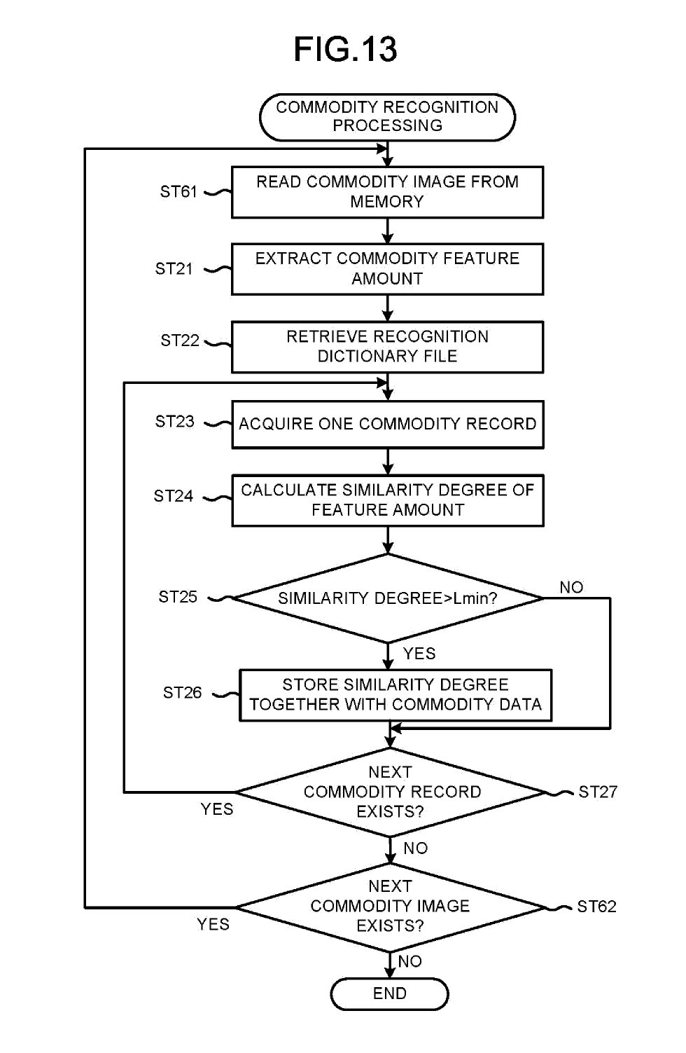

FIG. 13 is a flowchart specifically illustrating a procedure of the commodity recognition processing. In addition, the processing action the same as that in the commodity recognition processing of the first embodiment shown in FIG. 6 is assigned with the same reference mark, and is not repeatedly described.

As shown in FIG. 13, in the third embodiment, the commodity image stored in the commodity image memory is read in the storage order (ACT ST61). Then the processing from ACT ST21 to ACT ST27 of the first embodiment is executed every time the commodity image is read.

In ACT ST27, if it is confirmed that unprocessed data record does not exist in the recognition dictionary file 500 (NO in ACT ST27), the CPU 111 confirms whether or not unprocessed commodity image is stored in the commodity image memory (ACT ST62). If unprocessed commodity image is stored (YES in ACT ST62), the CPU 111 returns to the processing in ACT ST61. That is, the CPU 111 reads a next commodity image from the commodity image memory and then executes the processing from ACT ST 21 to ACT ST27. If it is confirmed that unprocessed commodity image is not stored in the commodity image memory (NO in ACT ST62), the commodity recognition processing is ended.

If the commodity recognition processing is ended, the CPU 111 executes the recognition result processing the same as that of the first embodiment (ACT ST17).

In the commodity recognition apparatus 1 according to the third embodiment, when the commodity is put in front of the reading window 1B, the barcode reading processing is executed. In addition, the commodity image detected from the captured image is stored in the commodity image memory. If the result of the barcode reading processing is that the barcode is read, commodity ID obtained from the barcode is sent to the POS terminal 2.

If the commodity is moved out from the image capturing area while the barcode is not read, in the commodity recognition apparatus 1, the commodity recognition processing is executed using the commodity image stored in the commodity image memory. Then the commodity ID of the commodity selected from the commodity candidates recognized through the commodity recognition processing or the determined commodity is sent to the POS terminal 2.

Therefore, the processing burden of the commodity recognition apparatus 1 is lightened since the commodity recognition processing is not executed for the commodity attached with a barcode.

In addition, the present invention is not limited to the embodiments stated above.

For example, in the embodiments stated above, if the commodity image is not detected from the image captured by the camera 14, CPU 111 regards that the photographing period of the commodity is ended. However, the timing for regarding that the photographing period of the commodity is ended is not limited to this. For example, when it is confirmed that the distance to the commodity is greater than a specified value, the photographing period of the commodity is ended even in a case where commodity image is detect from the captured image.

In addition, in the embodiments stated above, a buzzer serving as a notification device for notifying that the commodity candidate recognized through the commodity recognition processing is specified to one commodity item is exemplarily described. However, the notification device is not limited to the buzzer. For example, that the commodity candidate is specified to one commodity item may also be notified by displaying a given message on the panel display section 12a.

In addition, in the embodiments stated above, the CPU 111 of the commodity recognition apparatus 1 has all functions (programs) as a processor. Functions as a processor may also be dispersed to the CPU 111 of the commodity recognition apparatus 1 and the CPU 211 of the POS terminal 2. Alternatively, the commodity recognition apparatus 1 may be incorporated in the POS terminal 2, and the CPU 211 of the POS terminal 2 has all functions as a processor. In this case, the areas of the candidate commodity memory 600 and the commodity image memory are guaranteed in the RAM 213 of the POS terminal 2.

In addition, the areas of the candidate commodity memory 600 and the commodity image memory may also be formed in other storage medium, for example, the HDD 214, instead of the RAM. In the present embodiment, the storage media for storing the commodity image detected from the image acquired by the image interface are all included in the scope of the commodity image memory.

In addition, in the embodiments above, a control program realizing the functions of the present invention is prerecorded in the ROM112 serving as a program storage section inside the apparatus. However, it is not limited to this. The same program can be also downloaded to the apparatus from a network. Alternatively, the same program recorded in a recording medium can be also installed in the apparatus. The form of the recording medium is not limited as long as the recording medium can store programs like a CD-ROM and a memory card and is readable by an apparatus. Further, the function realized by an installed or downloaded program can also be realized through the cooperation with an OS (Operating System) installed in the apparatus. In addition, the program of the present embodiment can be also incorporated in a portable information terminal like a mobile phone with a communication function or a so-called PDA to realize the functions.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity recognition apparatus, comprising:
an image interface configured to acquire a commodity image captured by a camera; and
a processor configured to detect a commodity image from the image acquired by the image interface, carry out a commodity recognition processing for recognizing a commodity candidate according to feature amount extracted from the commodity image and a code reading processing for reading a commodity recognition code from the same commodity image in parallel, determine the commodity recognition code if the commodity recognition code is read through the code reading processing, and output a result of the commodity recognition processing if a photographing period of the commodity is ended while the commodity recognition code is not read.

2. The commodity recognition apparatus according to claim 1, further comprising:
a buzzer configured to give a notification if the highest similarity degree of the commodity candidate recognized through the commodity recognition processing exceeds a determination threshold value.

3. The commodity recognition apparatus, further comprising:
an image interface configured to acquire a commodity image captured by a camera;
a commodity image memory configured to store a commodity image detected from the image acquired by the image interface; and
a processor configured to detect a commodity image from the image acquired by the image interface, try to read a commodity recognition code from the commodity image, determine the commodity recognition code if the commodity recognition code is read, and output a recognition result after recognizing a commodity candidate according to feature amount extracted from the commodity image stored in the commodity image memory if a photographing period of the commodity is ended while the commodity recognition code is not read.

4. The commodity recognition apparatus according to claim 1, wherein
the processor regards that the photographing period of the commodity is ended if the commodity image cannot be detected from the image.

5. A commodity recognition method, comprising:
detecting a commodity image from the image acquired by the image interface, carrying out a commodity recognition processing for recognizing a commodity candidate according to feature amount extracted from the commodity image and a code reading processing for reading a commodity recognition code from the same commodity image in parallel, determine the commodity recognition code if the commodity recognition code is read through the code reading processing, and output a result of the commodity recognition processing if a photographing period of the commodity is ended while the commodity recognition code is not read.

6. The commodity recognition method according to claim 5, further comprising:
enabling a buzzer to give a notification if the highest similarity degree of the commodity candidate recognized through the commodity recognition processing exceeds a determination threshold value.
